(19) United States
(12) Patent Application Publication
(10) Pub. No.: US 2024/0243317 A1
(43) Pub. Date: Jul. 18, 2024

(54) METAL-CARBON DIOXIDE BATTERY INCLUDING ANION EXCHANGE MEMBRANE

(71) Applicants: HYUNDAI MOTOR COMPANY, Seoul (KR); KIA CORPORATION, Seoul (KR); UIF (UNIVERSITY INDUSTRY FOUNDATION), YONSEI UNIVERSITY, Seoul (KR)

(72) Inventors: Yun Su Lee, Yongin-si (KR); Ji Hoon Jang, Suwon-si (KR); Dongil Lee, Goyang-si (KR); Yongsung Jo, Seoul (KR); Eunsaem Park, Seoul (KR)

(21) Appl. No.: 18/240,024

(22) Filed: Aug. 30, 2023

(30) Foreign Application Priority Data
Jan. 6, 2023 (KR) 10-2023-0002235

(51) Int. Cl. H01M 8/06; H01M 4/90; H01M 8/04082; H01M 8/1023; H01M 8/103; H01M 8/1032; H01M 8/18

(52) U.S. Cl. CPC H01M 8/06; H01M 4/9016; H01M 8/04201; H01M 8/1023; H01M 8/103; H01M 8/1032; H01M 8/188

(57) ABSTRACT

A metal-carbon dioxide battery includes an anion exchange membrane. The metal-carbon dioxide battery includes an anode, a cathode, the anion exchange membrane located between the anode and the cathode, a first supply unit configured to provide a first electrolyte to the anode, and a second supply unit configured to provide a second electrolyte including protons and bicarbonate ions to the cathode.

### CROSS REFERENCE TO RELATED APPLICATIONS

This application claims under 35 U.S.C. § 119(a) the benefit of priority to Korean Patent Application No. 10-2023-0002235 filed on Jan. 6, 2023, the entire contents of which are incorporated herein by reference.

### BACKGROUND

### (a) Technical Field

The present disclosure relates to a metal-carbon dioxide battery including an anion exchange membrane.

### (b) Background Art

In order to keep pace with development of renewable energy corresponding to recent climate change, research on electrochemical water electrolysis is being actively performed. Further, the importance of technologies to capture, store and convert carbon dioxide (CO₂) so as to reduce greenhouse gas emissions continues to grow.

A zinc/aluminum (Zn/Al)-based aqueous battery system is a very economical metal anode candidate in terms of price and reserves. The zinc/aluminum (Zn/Al)-based aqueous battery system is a system that simultaneously produces hydrogen and captures carbon dioxide in the form of a salt, such as KHCO₃.

The above information disclosed in this Background section is only for enhancement of understanding of the background of the disclosure and therefore it may contain information that does not form the prior art that is already known in this country to a person of ordinary skill in the art.

### SUMMARY

The present disclosure has been made in an effort to solve the above-described problems associated with the prior art, and it is an object of the present disclosure to provide a metal-carbon dioxide battery including an anion exchange membrane.

In one aspect, the present disclosure provides a metal-carbon dioxide battery including an anode, a cathode, an anion exchange membrane located between the anode and the cathode, a first supply unit configured to provide a first electrolyte to the anode, and a second supply unit configured to provide a second electrolyte including protons and bicarbonate ions to the cathode.

In a preferred embodiment, the anion exchange membrane may transport the bicarbonate ions, included in in the second electrolyte provided to the cathode, to the anode.

In another preferred embodiment, the anion exchange membrane may include at least one selected from the group consisting of poly(terphenylene), 1,4-diazabicyclo[2,2,2]octane-poly(ether sulfone), poly(aryl piperidinium), poly(phenylene oxide)-block-poly(vinyl benzyl trimethyl ammonium), and combinations thereof.

In still another preferred embodiment, the first supply unit may include a first storage tank configured to receive the first electrolyte, a first electrolyte supplement unit connected to the first storage tank so as to provide the first electrolyte to the first storage tank, and a first connection pipe configured to connect the first storage tank to the anode so as to provide the first electrolyte to the anode.

In yet another preferred embodiment, the first electrolyte may include an alkali metal hydroxide, and the alkali metal hydroxide may include at least one selected from the group consisting of sodium hydroxide, potassium hydroxide, and a combination thereof.

In still yet another preferred embodiment, the second supply unit may include a second storage tank configured to receive the second electrolyte, a first carbon dioxide supplier connected to the second storage tank so as to provide carbon dioxide to the second storage tank, and a second connection pipe configured to connect the second storage tank to the cathode so as to provide the second electrolyte to the cathode, and the second electrolyte including the protons and the bicarbonate ions may be formed in the second storage tank by reaction between water and the carbon dioxide.

In a further preferred embodiment, reactions represented by Reaction Formulas 2 to 4 may occur at the anode.

Reaction Formula 2:

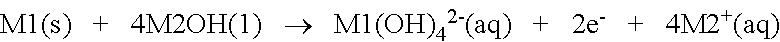

Reaction Formula 3:

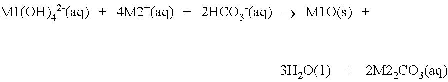

### Reaction Formula 4:

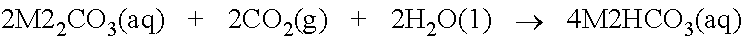

In the Reaction Formulas 2 to 4, M1 may include aluminum (Al) or zinc (Zn), and M2 may include sodium (Na) or potassium (K).

In another further preferred embodiment, the metal-carbon dioxide battery may further include a first filtering unit located at one side of the anode and configured to separate and recover an anode oxide from a first product discharged from the anode.

In still another further preferred embodiment, the metal-carbon dioxide battery may further include a second filtering unit located at a rear end of the first filtering unit and configured to separate and recover an alkali bicarbonate from a second product discharged from the first filtering unit.

In yet another further preferred embodiment, the first filtering unit may include a third storage tank configured to receive the first product discharged from the anode, a second carbon dioxide supplier configured to provide carbon dioxide to the third storage tank, and, as the carbon dioxide is supplied to the third storage tank, a pH of the first product may be lowered, and the anode oxide may be precipitated from the first product.

In still yet another further preferred embodiment, the second carbon dioxide supplier may provide the carbon dioxide to the third storage tank so that the pH of the first product is 10 to 12.

In a still further preferred embodiment, the first filtering unit may further include a first filter unit configured to separate the precipitated anode oxide from the first product.

In a yet still further preferred embodiment, the second filtering unit may include a fourth storage tank configured to receive the second product discharged from the first filtering unit, and a third carbon dioxide supplier configured to provide carbon dioxide to the fourth storage tank, and, as the carbon dioxide is supplied to the fourth storage tank, a pH of the second product may be lowered, and the alkali bicarbonate may be precipitated from the second product.

In still yet another preferred embodiment, the alkali bicarbonate may include sodium bicarbonate (NaHCO₃) or potassium bicarbonate (KHCO₃).

In a further preferred embodiment, the third carbon dioxide supplier may provide the carbon dioxide to the fourth storage tank so that the pH of the second product is 7 to 9.

In another further preferred embodiment, the second filtering unit may further include a second filter unit configured to separate the precipitated alkali bicarbonate from the second product.

In still another further preferred embodiment, the second filtering unit may be connected to the first supply unit, and unreacted substances discharged from the second filtering unit may be provided to the first supply unit.

In yet another further preferred embodiment, the metal-carbon dioxide battery may further include a separation unit located at one side of the cathode and configured to separate hydrogen gas from a third product discharged from the cathode.

In still yet another further preferred embodiment, the separation unit may be connected to the second supply unit, and unreacted substances discharged from the separation unit may be provided to the second supply unit.

Other aspects and preferred embodiments of the disclosure are discussed infra.

### BRIEF DESCRIPTION OF THE FIGURES

The above and other features of the present disclosure will now be described in detail with reference to certain exemplary embodiments thereof illustrated in the accompanying drawings which are given hereinbelow by way of illustration only, and thus are not limitative of the present disclosure, and wherein:

FIG. 1 shows a block diagram illustrating a conventional metal-carbon dioxide battery including a cation exchange membrane;

FIG. 2 shows a block diagram illustrating a metal-carbon dioxide battery including an anion exchange membrane according to the present disclosure;

FIG. 3 shows powder recovered from a first filter unit according to Example, observed with the naked eye;

FIG. 4 shows the result of X-ray diffraction (XRD) of the powder recovered from the first filter unit according to Example;

FIG. 5 shows powder recovered from a second filter unit according to Example, observed with the naked eye;

FIG. 6 shows the result of X-ray diffraction (XRD) of the powder recovered from the second filter unit according to Example; and

FIG. 7 shows the results of cell potentials measured by operating a metal-carbon dioxide battery according to Example and a metal-carbon dioxide battery according to Comparative Example.

It should be understood that the appended drawings are not necessarily to scale, presenting a somewhat simplified representation of various preferred features illustrative of the basic principles of the disclosure. The specific design features of the present disclosure as disclosed herein, including, for example, specific dimensions, orientations, locations, and shapes, will be determined in part by the particular intended application and use environment.

In the figures, reference numbers refer to the same or equivalent parts of the present disclosure throughout the several figures of the drawing.

### DETAILED DESCRIPTION

The above-described objects, other objects, advantages and features of the present disclosure will become apparent from the descriptions of embodiments given hereinbelow with reference to the accompanying drawings. However, the present disclosure is not limited to the embodiments disclosed herein and may be implemented in various different forms. The embodiments are provided to make the description of the present disclosure thorough and to fully convey the scope of the present disclosure to those skilled in the art.

In the following description of the embodiments, the same elements are denoted by the same reference numerals even when they are depicted in different drawings. In the drawings, the dimensions of structures may be exaggerated compared to the actual dimensions thereof, for clarity of description. In the following description of the embodiments, terms, such as “first” and “second”, may be used to describe various elements but do not limit the elements. These terms are used only to distinguish one element from other elements. For example, a first element may be named a second element, and similarly, a second element may be named a first element, without departing from the scope and spirit of the disclosure. Singular expressions may encompass plural expressions, unless they have clearly different contextual meanings.

In the following description of the embodiments, terms, such as “including”, “comprising” and “having”, are to be interpreted as indicating the presence of characteristics, numbers, steps, operations, elements or parts stated in the description or combinations thereof, and do not exclude the presence of one or more other characteristics, numbers, steps, operations, elements, parts or combinations thereof, or possibility of adding the same. In addition, it will be understood that, when a part, such as a layer, a film, a region or a plate, is said to be “on” another part, the part may be located “directly on” the other part or other parts may be interposed between the two parts. In the same manner, it will be understood that, when a part, such as a layer, a film, a region or a plate, is said to be “under” another part, the part may be located “directly under” the other part or other parts may be interposed between the two parts.

All numbers, values and/or expressions representing amounts of components, reaction conditions, polymer compositions and blends used in the description are approximations in which various uncertainties in measurement generated when these values are acquired from essentially different things are reflected and thus it will be understood that they are modified by the term “about”, unless stated otherwise. In addition, it will be understood that, if a numerical range is disclosed in the description, such a range includes all continuous values from a minimum value to a maximum value of the range, unless stated otherwise. Further, if such a range refers to integers, the range includes all integers from a minimum integer to a maximum integer, unless stated otherwise.

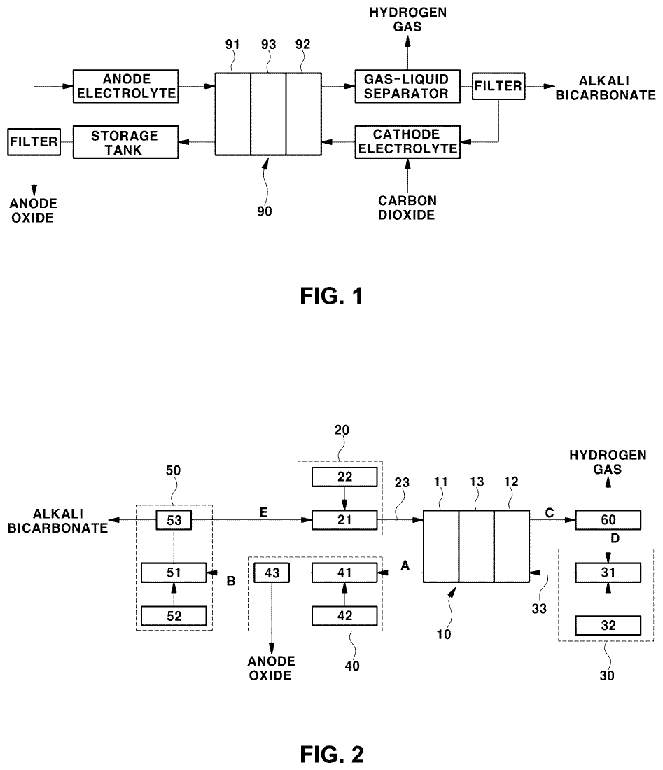

FIG. 1 shows a block diagram illustrating a conventional hydrogen generation and carbon dioxide storage system (referred to hereinafter as a “conventional system”) having a metal-carbon dioxide battery 90 including a cation exchange membrane 93. In the conventional system, the cation exchange membrane 93 which transports cations is located between an anode 91 and a cathode 92. When an anode electrolyte including aqueous potassium hydroxide solution is provided to the anode 91, the following reactions occur.

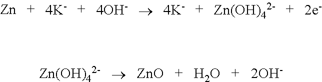

In the above reactions, Zn indicates the anode 91, and ZnO, which is an anode oxide, and potassium cations (K) are generated through the reactions. The anode oxide may be recovered through a storage tank and a filter. The potassium cations (K+) migrate to the cathode 92 through the cation exchange membrane 93.

When a cathode electrolyte, such as aqueous potassium carbonate (K₂CO₃) solution or aqueous potassium bicarbonate (KHCO₃) solution, is provided to the cathode 92, the following reactions occur.

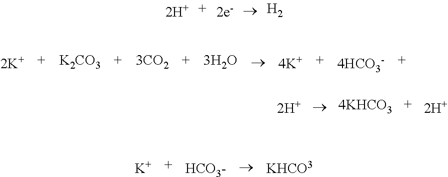

In the above reactions, protons may be generated by dissolution of carbon dioxide provided to the cathode electrolyte. Hydrogen gas and potassium bicarbonate (KHCO₃) are generated at the cathode 92. The hydrogen gas may be separated and recovered by a gas-liquid separator. The potassium bicarbonate (KHCO₃) may be separated and recovered through a filter or the like.

In the conventional system, bicarbonate is precipitated at the cathode 92, and may hinder generation of hydrogen gas. Further, the bicarbonate blocks the flow of the cathode electrolyte, and thereby, the metal-carbon dioxide battery 90 may not be operated.

Further, since filtering devices, such as the filters configured to recover the anode oxide (Zn) and potassium bicarbonate (KHCO₃), are respectively provided at the anode 91 and the cathode 92, the conventional system has a very large volume.

FIG. 2 shows a block diagram illustrating a metal-carbon dioxide battery including an anion exchange membrane 13 according to the present disclosure.

The metal-carbon dioxide battery according to the present disclosure may include a reaction unit 10 including an anode 11, a cathode 12 and the anion exchange membrane 13 located between the anode 11 and the cathode 12, a first supply unit 20 configured to provide a first electrolyte to the anode 11, a second supply unit 30 configured to provide a second electrolyte to the cathode 12, a first filtering unit 40 configured to separate and recover an anode oxide from a first product A discharged from the anode 11, a second filtering unit 50 configured to separate and recover alkali bicarbonate from a second product B discharged from the first filtering unit 40, and a separation unit 60 configured to separate hydrogen gas from a third product C discharged from the cathode 12.

The cathode 12 may include at least one selected from the group consisting of carbon paper, carbon fiber, carbon felt, carbon cloth, metal foam, a metal thin film, and combinations thereof. The cathode 12 may further include an active metal supported on the carbon paper or the like. The active metal may include a precious metal, such as platinum (Pt), and/or a transition metal, such as nickel (Ni) or molybdenum (Mo), without being limited thereto.

The second supply unit 30 may include a second storage tank 31 configured to receive the second electrolyte, a first carbon dioxide supplier 32 connected to the second storage tank 31 so as to provide carbon dioxide to the second storage tank 31, and a second connection pipe 33 configured to connect the second storage tank 31 to the cathode 12 so as to provide the second electrolyte to the cathode 12.

The second electrolyte may include protons (H+) and bicarbonate ions (HCO₃⁻).

Before the metal-carbon dioxide battery is operated, water (H₂O) may be stored in the second storage tank 31. When carbon dioxide is provided to the second storage tank 31, the second electrolyte including protons (H+) and bicarbonate ions (HCO₃⁻) is formed by the following dissolution of the carbon dioxide.

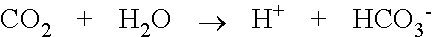

When the second electrolyte is provided to the cathode 12, hydrogen gas may be generated by following Reaction Formula 1.

Reaction Formula 1:

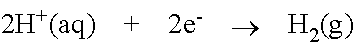

Bicarbonate ions (HCO₃⁻) included in the second electrolyte may migrate to the anode 11 through the anion exchange membrane 13.

The third product C discharged from the cathode 12 is provided to the separation unit 60. The third product C may include unreacted substances of the second electrolyte, hydrogen gas, etc. The unreacted substances of the second electrolyte may include water, carbon dioxide, protons (H⁺), and bicarbonate ions (HCO₃⁻).

The separation unit 60 may be located at one side of the cathode 12, and may separate hydrogen gas from the third product C. Here, the location of the separation unit 60 at the side of the cathode 12 is not limited to the meaning that the separation unit 60 is located near the cathode 12, and may indicate that the separation unit 60 is connected to the cathode 12 by a conduit or the like so as to receive the third product C discharged from the cathode 12.

The separation unit 60 may include a gas-liquid separator configured to separate and recover hydrogen gas from the third product C.

The separation unit 60 may be connected to the second supply unit 30. Concretely, the separation unit 60 may be connected to the second supply unit 30 by a conduit or the like. Unreacted substances D discharged from the separation unit 60 may be provided to the second supply unit 30 so as to be circulated as the second electrolyte.

The anion exchange membrane 13 may transmit bicarbonate ions (HCO₃⁻), included in the second electrolyte provided to the cathode 12, to the anode 11.

The anion exchange membrane 13 may include a material having anion conductivity. The anion exchange membrane 13 may include at least one selected from the group consisting of poly(terphenylene), 1,4-diazabicyclo[2,2,2]octane-poly(ether sulfone), poly(aryl piperidinium), poly(phenylene oxide)-block-poly(vinyl benzyl trimethyl ammonium), and combinations thereof.

The anion exchange membrane 13 may include a polymer acquired by substituting the main chain or the side chain of the above-described polymer with an anion conductive group which is positively charged, such as an amine group.

Since the anion exchange membrane 13 includes the anion conductive group which is positively charged, the anion exchange membrane 13 repels other cations, and may thus not transport alkali metal cations of the anode 11, which will be described below, to the cathode 12.

Further, the anion exchange membrane 13 conducts anions but does not transmit the first electrolyte and the second electrolyte, and may thus prevent the first electrolyte and the second electrolyte from being mixed.

The anode 11 may include at least one selected from the group consisting of aluminum, zinc, and a combination thereof.

The first supply unit 20 may include a first storage tank 21 configured to receive the first electrolyte, a first electrolyte supplement unit 22 connected to the first storage tank 21 so as to provide the first electrolyte to the first storage tank 21, and a first connection pipe 23 configured to connect the first storage tank 21 to the anode 11 so as to provide the first electrolyte to the anode 11.

The first electrolyte may include an alkali metal hydroxide. The alkali metal hydroxide may include at least one selected from the group consisting of sodium hydroxide, potassium hydroxide, and a combination thereof.

When the first electrolyte is provided to the anode 11, the anode 11 may be oxidized by following Reaction Formulas 2 and 3, and bicarbonate may be generated by following Reaction Formula 4.

Reaction Formula 2:

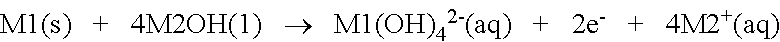

Reaction Formula 3:

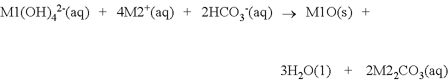

Reaction Formula 4:

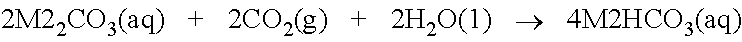

In Reaction Formulas 2 to 4, M1 may include aluminum (Al) or zinc (Zn), and M2 may include sodium (Na) or potassium (K).

In Reaction Formula 4, carbon dioxide may be unreacted carbon dioxide which is circulated together with the first electrolyte and supplied to the anode 11, among carbon dioxide provided by a second carbon dioxide supplier 42 and a third carbon dioxide supplier 52, which will be described below.

The first product A discharged from the anode 11 is provided to the first filtering unit 40. The first product A may include the anode oxide M1O, water, an alkali bicarbonate, etc. The alkali bicarbonate may include sodium bicarbonate (NaHCO₃) or potassium bicarbonate (KHCO₃).

The first filtering unit 40 is located at one side of the anode 11, and may separate and recover the anode oxide M1O from the first product A. Here, the location of the first filtering unit 40 at the side of the anode 11 is not limited to the meaning that the first filtering unit 40 is located near the anode 11, and may indicate that the first filtering unit 40 is connected to the anode 11 by a conduit or the like so as to receive the first product A discharged from the anode 11.

The first filtering unit 40 may include a third storage tank 41 configured to receive the first product A discharged from the anode 11, the second carbon dioxide supplier 42 configured to provide carbon dioxide to the third storage tank 41, and a first filter unit 43 configured to separate the precipitated anode oxide from the first product A.

As the second carbon dioxide supplier 42 supplies carbon dioxide to the third storage tank 41, the pH of the first product A may be lowered, and the anode oxide M1O may be precipitated from the first product A. The pH of the first product A may be adjusted to a pH at which the anode oxide M1O is precipitated as a solid based on the Pourbaix diagram of the anode oxide M1O. For example, when the anode oxide M1O is ZnO, the second carbon dioxide supplier 42 may adjust the pH of the first product A to 12 or less. The lower limit of the pH of the first product A is not limited to a specific value, and may be 10 or more. When the pH of the first product A is less than 10, the alkali bicarbonate is not precipitated, and may thus not be separated and recovered.

The first filter unit 43 may employ any filter which is generally used in the art to which the present disclosure pertains, as long as the filter may separate the anode oxide M1O from the first product A.

The first filtering unit 40 may provide the second product B, acquired by separating the anode oxide from the first product A, to the second filtering unit 50. The second product B may include water, the alkali bicarbonate, unreacted carbon dioxide, etc.

The second filtering unit 50 may be located at the rear end of the first filtering unit 40, and may separate and recover the alkali bicarbonate (M2HCO₃) from the second product B. Here, the location of the second filtering unit 50 at the rear end of the first filtering unit 40 is based on the flow direction of the second product B, and the positions of the first filtering unit 40 and the second filtering unit 50 are not limited to an orientation, such as an upward, downward, leftward or rightward direction.

The second filtering unit 50 may include a fourth storage tank 51 configured to receive the second product B discharged from the first filtering unit 40, the third carbon dioxide supplier 52 configured to provide carbon dioxide to the fourth storage tank 51, and a second filter unit 53 configured to separate the precipitated alkali bicarbonate (M2HCO₃).

As the third carbon dioxide supplier 52 supplies carbon dioxide to the fourth storage tank 51, the pH of the second product B may be lowered, and the alkali bicarbonate (M2HCO₃) may be precipitated from the second product B. The pH of the second product B may be adjusted to a pH at which the alkali bicarbonate (M2HCO₃) is precipitated as a solid based on the Pourbaix diagram of the alkali bicarbonate (M2HCO₃). For example, when the alkali bicarbonate (M2HCO₃) is KHCO₃, the third carbon dioxide supplier 52 may adjust the pH of the second product B to 7 to 9. When the pH of the second product B is less than 7 or exceeds 9, the ratio of the alkali bicarbonate (M2HCO₃) in the electrolyte may be decreased and thus it may be difficult to precipitate and recover the alkali bicarbonate (M2HCO₃).

The second filter unit 53 may employ any filter which is generally used in the art to which the present disclosure pertains, as long as the filter may separate the alkali bicarbonate (M2HCO₃) from the second product B.

The first filtering unit 50 may be connected to the first supply unit 20, and unreacted substances E discharged from the second filtering unit 50 may be provided to the first supply unit 20. The unreacted substances E may include carbon dioxide provided by the second carbon dioxide supplier 42 and the third carbon dioxide supplier 52, water, the unreacted first electrolyte, etc.

The unreacted substances E together with the first electrolyte in the first supply unit 20 may be circulated to the anode 11. Since the first electrolyte is exhausted depending on Reaction Formulas 2 to 4, the first electrolyte supplement unit 22 may provide a proper amount of the first electrolyte to the unreacted substances E so as to supplement the first electrolyte, and then, the first electrolyte may be provided to the anode 11.

The metal-carbon dioxide battery according to the present disclosure includes the anion exchange membrane 13 so as to store and recover carbon dioxide as an alkali bicarbonate at the anode 11, in contrast to the conventional system. No alkali bicarbonate is generated at the cathode 12, and thus does not hinder generation of hydrogen gas at the cathode 12 and prevents stoppage of operation of the battery due to blocking of the flow of the second electrolyte.

In the metal-carbon dioxide battery, bicarbonate ions migrate from the cathode 12 to the anode 11 through the anion exchange membrane 13, and thereby, the pH of the second electrolyte is maintained without change.

The metal-carbon dioxide battery receives carbon dioxide from the first carbon dioxide supplier 32 located at one side of the cathode 12 and the second carbon dioxide supplier 42 and the third carbon dioxide supplier 52 located at one side of the anode 11, and store the carbon dioxide in the form of the alkali bicarbonate, thereby having a high carbon dioxide throughput compared to the conventional system.

The metal-carbon dioxide battery may include filtering devices, i.e., the first and second filtering unit 40 and 50, only at the anode 11, thereby being capable of generating hydrogen and storing carbon dioxide through a simple structure compared to the conventional system.

Hereinafter, the present disclosure will be described in more detail through the following examples. The following examples serve merely to exemplarily describe the present disclosure, and are not intended to limit the scope of the disclosure.

### Example

A metal-carbon dioxide battery having the same structure as the metal-carbon dioxide battery shown in FIG. 2 was constructed. Zinc foil was used as an anode, and nickel-molybdenum supported on a support was used as a cathode. A reaction unit was prepared by interposing an anion exchange membrane between the anode and the cathode. Fumasep FAAM-40 manufactured by FuMA-Tech GmbH was used as the anion exchange membrane.

Aqueous potassium hydroxide (KOH) solution as a first electrolyte was provided to the anode. A second electrolyte including protons and bicarbonate ions was prepared by providing carbon dioxide to water received in a second storage tank, and the second electrolyte was provided to the anode.

The metal-carbon dioxide battery was operated by driving the reaction unit.

Reactions occurring in the reaction unit are as follows.

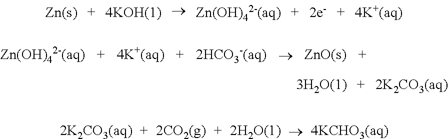

Hydrogen gas was separated from a third product discharged from the cathode by supplying the third product to a gas-liquid separator. Thereafter, the remainder of the third product was provided to a second supply unit so as to be circulated.

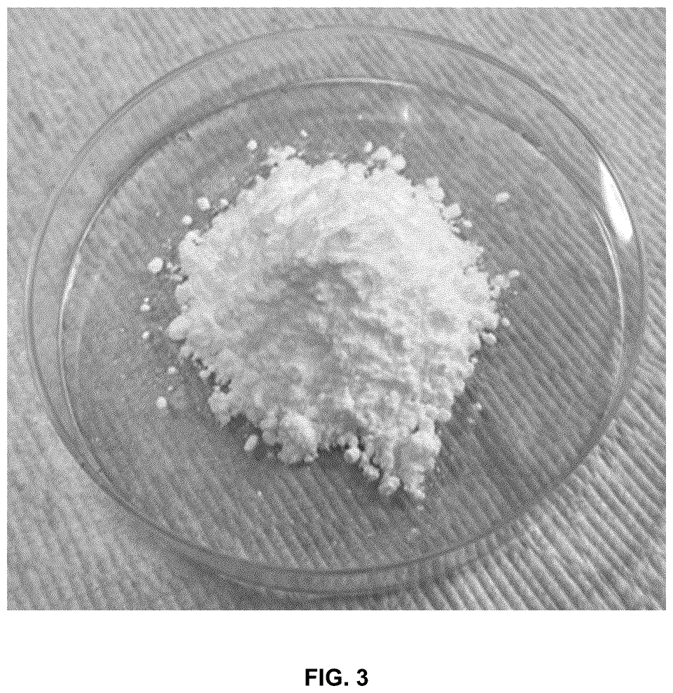

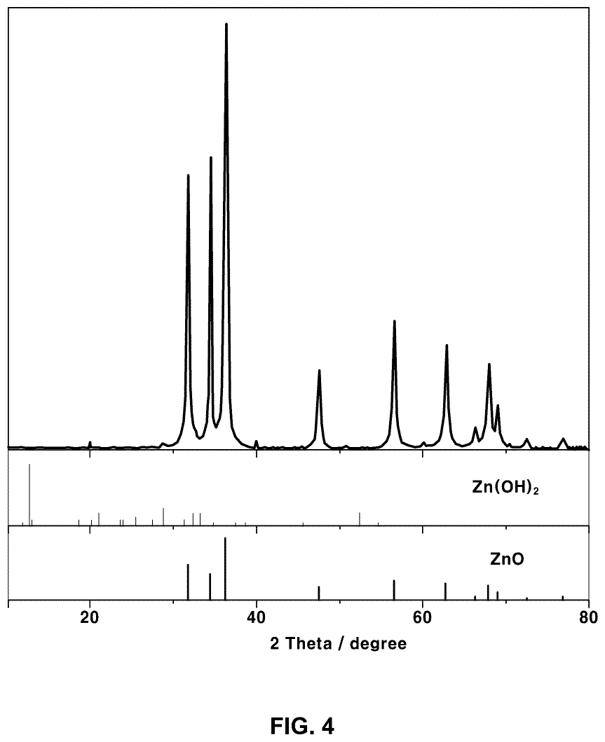

A first product discharged from the anode was supplied to a third storage tank. Zinc oxide (ZnO) was precipitated by supplying carbon dioxide to the first product so that the pH of the first product was about 12, and was then separated by a first filter unit. FIG. 3 shows powder recovered from the first filter unit, observed with the naked eye. FIG. 4 shows the result of X-ray diffraction (XRD) of the powder recovered from the first filter unit. Thereby, it was confirmed that the powder was zinc oxide (ZnO).

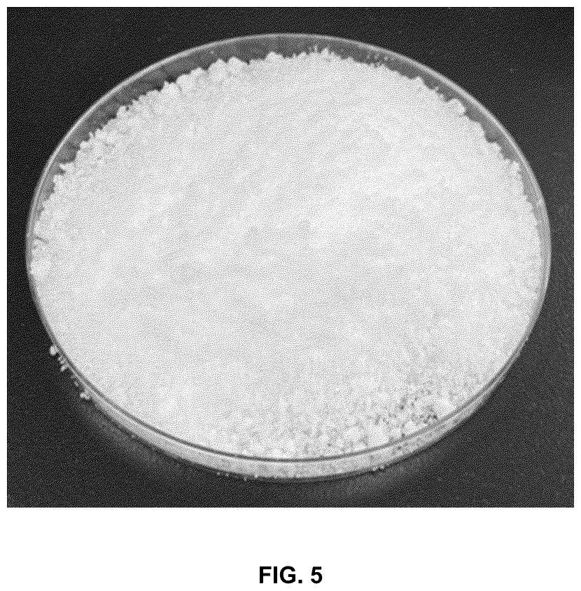

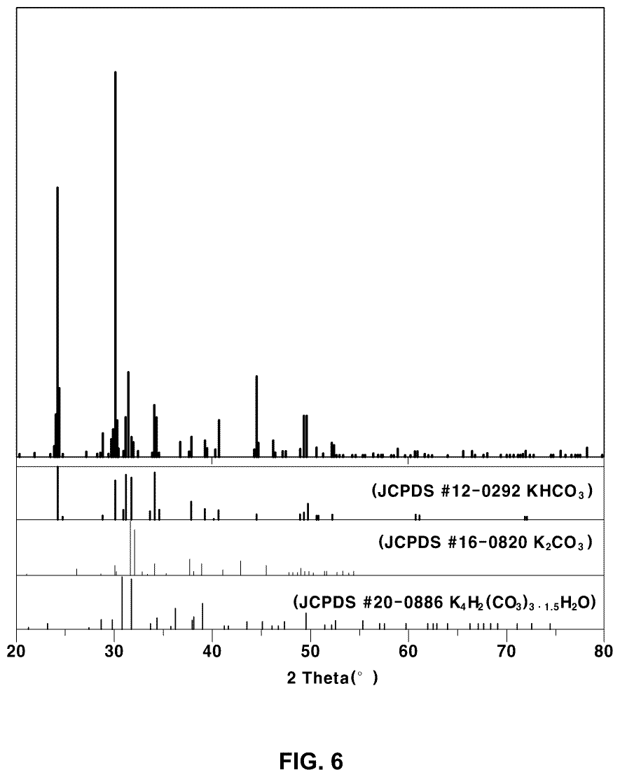

After separating zinc oxide (ZnO), a second product was supplied to a fourth storage tank. Potassium bicarbonate (KHCO₃) was precipitated by supplying carbon dioxide to the second product so that the pH of the second product was about 8, and was then separated by a second filter unit. FIG. 5 shows of powder recovered from the second filter unit, observed with the naked eye. FIG. 6 shows the result of X-ray diffraction (XRD) of the powder recovered from the second filter unit. Thereby, it was confirmed that the powder was potassium bicarbonate (KHCO₃).

After separating potassium bicarbonate (KHCO₃), the remainder of the second product was provided to a first supply unit so as to be circulated.

### Comparative Example

A metal-carbon dioxide battery having the same structure as the metal-carbon dioxide battery shown in FIG. 1 was constructed. Zinc foil was used as an anode, and nickel-molybdenum supported on a support was used as a cathode. A reaction unit was prepared by interposing a cation exchange membrane including Nafion between the anode and the cathode.

Aqueous potassium hydroxide (KOH) solution as an anode electrolyte was provided to the anode. An electrolyte including protons and bicarbonate ions as a cathode electrolyte was provided to the cathode.

The metal-carbon dioxide battery was operated by driving the reaction unit.

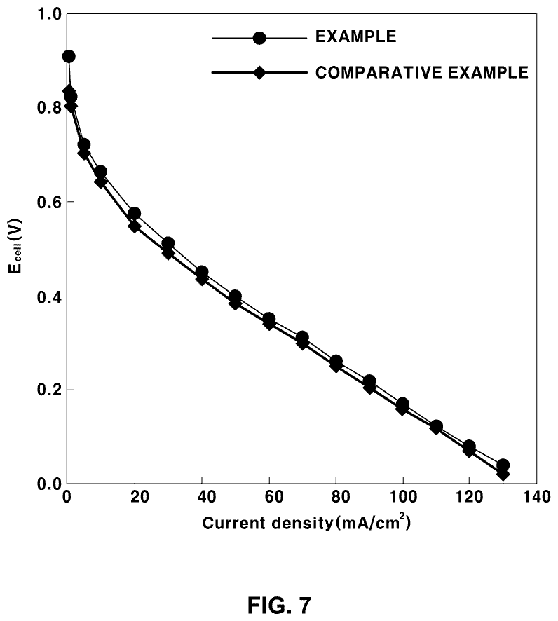

FIG. 7 shows the results of cell potentials measured by operating the metal-carbon dioxide battery according to Example and the metal-carbon dioxide battery according to Comparative Example. Referring to this figure, it may be confirmed, from the fact that, as the cell resistances of the respective batteries are reduced, the current densities of the respective batteries at a point where a cell potential Ecell becomes zero are similar, such that the metal-carbon dioxide battery according to the present disclosure exhibits activity equal to or more than the activity of the conventional metal-carbon dioxide battery.

The metal-carbon dioxide battery according to Example is advantageous in that, even though the activities of the metal-carbon dioxide battery according to Example and the metal-carbon dioxide battery according to Comparative Example are similar, the metal-carbon dioxide battery according to Example may capture and store a larger amount of carbon dioxide than the metal-carbon dioxide battery according to Comparative Example, and the pH of the electrolyte supplied to the cathode of the metal-carbon dioxide battery according to Example may be uniformly maintained without change.

As is apparent from the above description, the present disclosure provides a metal-carbon dioxide battery which may effectively achieve generation of hydrogen at a cathode.

The present disclosure provides a metal-carbon dioxide battery which does not block the flow of an electrolyte so as to be stably operated.

The present disclosure provides a metal-carbon dioxide battery which has a high capturing amount of carbon dioxide compared to a metal-carbon dioxide battery including a cation exchange membrane.

The present disclosure provides a metal-carbon dioxide battery which has a simplified configuration compared to the metal-carbon dioxide battery including the cation exchange membrane.

The disclosure has been described in detail with reference to preferred embodiments thereof. However, it will be appreciated by those skilled in the art that changes may be made in these embodiments without departing from the principles and spirit of the disclosure, the scope of which is defined in the appended claims and their equivalents.

1. A metal-carbon dioxide battery comprising:
an anode;
a cathode;
an anion exchange membrane interposed between the anode and the cathode;
a first supply unit configured to provide a first electrolyte to the anode; and
a second supply unit configured to provide a second electrolyte comprising protons and bicarbonate ions to the cathode.

2. The metal-carbon dioxide battery of claim 1, wherein the anion exchange membrane is configured to transport the bicarbonate ions, comprised in the second electrolyte provided to the cathode, to the anode.

3. The metal-carbon dioxide battery of claim 1, wherein the anion exchange membrane comprises at least one selected from the group consisting of poly(terphenylene), 1,4-diazabicyclo[2,2,2]octane-poly(ether sulfone), poly(aryl piperidinium), poly(phenylene oxide)-block-poly(vinyl benzyl trimethyl ammonium), and combinations thereof.

4. The metal-carbon dioxide battery of claim 1, wherein the first supply unit comprises:
a first storage tank configured to receive the first electrolyte;
a first electrolyte supplement unit connected to the first storage tank to provide the first electrolyte to the first storage tank; and
a first connection pipe configured to connect the first storage tank to the anode to provide the first electrolyte to the anode.

5. The metal-carbon dioxide battery of claim 1, wherein:
the first electrolyte comprises an alkali metal hydroxide; and
the alkali metal hydroxide comprises at least one selected from the group consisting of sodium hydroxide, potassium hydroxide, and combinations thereof.

6. The metal-carbon dioxide battery of claim 1, wherein the second supply unit comprises:
a second storage tank configured to receive the second electrolyte;
a first carbon dioxide supplier connected to the second storage tank to provide carbon dioxide to the second storage tank; and
a second connection pipe configured to connect the second storage tank to the cathode to provide the second electrolyte to the cathode;
wherein the second electrolyte comprising the protons and the bicarbonate ions is formed in the second storage tank by a reaction between water and the carbon dioxide.

7. The metal-carbon dioxide battery of claim 1, wherein reactions represented by Reaction Formulas 2 to 4 occur at the anode,
Reaction Formula 2: 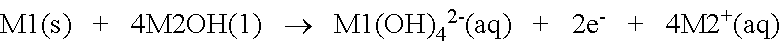
Reaction Formula 3: 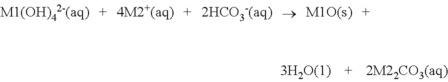
Reaction Formula 4: 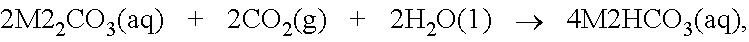
wherein, in the Reaction Formulas 2 to 4, M1 comprises aluminum (Al) or zinc (Zn), and M2 comprises sodium (Na) or potassium (K).

8. The metal-carbon dioxide battery of claim 1, wherein the metal-carbon dioxide battery further comprises a first filtering unit located at one side of the anode and configured to separate and recover an anode oxide from a first product discharged from the anode.

9. The metal-carbon dioxide battery of claim 8, wherein the metal-carbon dioxide battery further comprises a second filtering unit located at a rear end of the first filtering unit and configured to separate and recover an alkali bicarbonate from a second product discharged from the first filtering unit.

10. The metal-carbon dioxide battery of claim 8, wherein the first filtering unit comprises:
a third storage tank configured to receive the first product discharged from the anode; and
a second carbon dioxide supplier configured to provide carbon dioxide to the third storage tank;
wherein, as the carbon dioxide is supplied to the third storage tank, a pH of the first product is lowered, and the anode oxide is precipitated from the first product.

11. The metal-carbon dioxide battery of claim 10, wherein the second carbon dioxide supplier provides the carbon dioxide to the third storage tank so that the pH of the first product is 10 to 12.

12. The metal-carbon dioxide battery of claim 10, wherein the first filtering unit further comprises a first filter unit configured to separate the precipitated anode oxide from the first product.

13. The metal-carbon dioxide battery of claim 9, wherein the second filtering unit comprises:
a fourth storage tank configured to receive the second product discharged from the first filtering unit; and
a third carbon dioxide supplier configured to provide carbon dioxide to the fourth storage tank;
wherein, as the carbon dioxide is supplied to the fourth storage tank, a pH of the second product is lowered, and the alkali bicarbonate is precipitated from the second product.

14. The metal-carbon dioxide battery of claim 13, wherein the alkali bicarbonate comprises sodium bicarbonate (NaHCO₃) or potassium bicarbonate (KHCO₃).

15. The metal-carbon dioxide battery of claim 13, wherein the third carbon dioxide supplier provides the carbon dioxide to the fourth storage tank so that the pH of the second product is 7 to 9.

16. The metal-carbon dioxide battery of claim 13, wherein the second filtering unit further comprises a second filter unit configured to separate the precipitated alkali bicarbonate from the second product.

17. The metal-carbon dioxide battery of claim 9, wherein the second filtering unit is connected to the first supply unit, and unreacted substances discharged from the second filtering unit are provided to the first supply unit.

18. The metal-carbon dioxide battery of claim 1, wherein the metal-carbon dioxide battery further comprises a separation unit located at one side of the cathode and configured to separate hydrogen gas from a third product discharged from the cathode.

19. The metal-carbon dioxide battery of claim 18, wherein the separation unit is connected to the second supply unit, and unreacted substances discharged from the separation unit are provided to the second supply unit.
